(19) United States
(12) Patent Application Publication
(10) Pub. No.: US 2008/0154989 A1
(43) Pub. Date: Jun. 26, 2008

(54) DATA BACKUP SYSTEM AND METHOD ASSOCIATED THEREWITH

(75) Inventor: ALAN A. ARMAN, POWELL, OH (US)

Correspondence Address: CALFEE HALTER & GRISWOLD, LLP, 800 SUPERIOR AVENUE, SUITE 1400, CLEVELAND, OH, 44114, US

(73) Assignee: BOXICOM, INC. (DBA 3X SYSTEMS), COLUMBUS, OH (US)

(21) Appl. No.: 11/962,943

(22) Filed: Dec. 21, 2007

Related U.S. Application Data
(60) Provisional application No. 60/871,433, filed on Dec. 21, 2006.

(51) Int. Cl. G06F 17/30

(52) U.S. Cl. 707/204; 707/E17.007

(57) ABSTRACT

A data backup system may include a data backup appliance, a locator service, and a data backup client in various embodiments. A method of providing a data backup service may include a) locating a data backup device at a first device address, b) backing up one or more stored files from at least one storage device to the data backup device at the first device address, c) maintaining address information for the data backup device at a locator service device, d) retrieving address information for the data backup device from the locator service device, and e) backing up at least one portion of at least one file backed up in b) to the data backup device at the second device address. Additional embodiments of the method of providing a data backup service are also provided.

### CROSS-REFERENCE TO RELATED APPLICATIONS

This application claims the benefit of U.S. Provisional Patent Application No. 60/871,433, filed Dec. 21, 2006, the contents of which are fully incorporated herein by reference.

### BACKGROUND

Data protection is required for all companies that use a computer system in any part of their business. A common approach to data protection is the use of data backups to create a copy of data that can be used to replace the original data if the original data is lost or damaged. A data backup system can be self administered or may be contracted out to a vendor or other third party for operation.

One leading data backup solution is to periodically store a data image onto a storage medium such as magnetic tape. Tape based solutions are used by approximately 80% of small/mid-sized companies as their primary backup strategy. A disadvantage of this approach is that it is highly manual. The computer network includes an attached tape recorder that can access the network, download data, and store it on data tapes. Often, there is an initial full backup of all data. Subsequently, only changes to data when compared to the initial full backup are stored on backup tapes. If restoration is required, the full backup and subsequent data changes are used to create a data image that represents a last known good state. Periodically, additional full data backups are done to create benchmarks and archives of the data.

Regardless of the backup strategy, tape backups require a great deal of manual intervention. Someone must install the tape backup hardware, install the software (usually provided by a separate vendor), label tapes, replace the tape in the drive with the correct tape every day, move the tapes offsite everyday and clean the tape drive on a regular basis. Such amount of human intervention is the number one source of reliability problems associated with tape backup solutions.

### SUMMARY

A method of providing a data backup service is provided. In one embodiment, the method includes: a) locating a data backup device at a first device address, b) backing up one or more stored files from at least one storage device to the data backup device at the first device address, c) maintaining address information for the data backup device at a locator service device in operative communication with the data backup device, d) retrieving address information for the data backup device from the locator service device, wherein the address information indicates the data backup device is identified by a second device address different from the first device address, and e) backing up at least one portion of one or more stored files from at least one storage device to the data backup device at the second device address.

Other embodiments of the invention are more fully described below. This summary does not limit the scope of the claims set forth below in any way. The words of the claims have all of their full ordinary meaning.

### DRAWINGS

These and other features, aspects, and advantages of the present invention will become better understood with regard to the accompanying drawings, following description, and appended claims.

FIG. 1 is a block diagram of an exemplary embodiment of a data backup system;

FIG. 2 is a flow chart of an exemplary embodiment of a process for providing a data backup service;

FIG. 3 is a block diagram of another exemplary embodiment of a data backup system;

FIG. 4 is a block diagram of an exemplary embodiment of a data backup appliance for the data backup system of FIG. 3;

FIG. 5 is a block diagram of an exemplary embodiment of a locator service for the data backup system of FIG. 3;

FIG. 6 is a block diagram of an exemplary embodiment of a data backup client for the data backup system of FIG. 3;

FIG. 7 is a flow chart of another exemplary embodiment of a process for providing a data backup service;

FIG. 8, in combination with FIG. 7, is a flow chart of another exemplary embodiment of a process for providing a data backup service;

FIG. 9, in combination with FIG. 7, is a flow chart of yet another exemplary embodiment of a process for providing a data backup service;

FIG. 10, in combination with FIG. 7, is a flow chart of still another exemplary embodiment of a process for providing a data backup service;

FIG. 11, in combination with FIG. 7, is a flow chart of still yet another exemplary embodiment of a process for providing a data backup service;

FIG. 12, in combination with FIG. 7, is a flow chart of another exemplary embodiment of a process for providing a data backup service;

FIG. 13, in combination with FIG. 7, is a flow chart of yet another exemplary embodiment of a process for providing a data backup service;

FIG. 14, in combination with FIG. 7, is a flow chart of still another exemplary embodiment of a process for providing a data backup service;

FIG. 15, in combination with FIG. 7, is a flow chart of still yet another exemplary embodiment of a process for providing a data backup service;

FIG. 16, in combination with FIG. 7, is a flow chart of another exemplary embodiment of a process for providing a data backup service;

FIG. 17 is a flow chart of yet another exemplary embodiment of a process for providing a data backup service;

FIG. 18, in combination with FIG. 17, is a flow chart of another exemplary embodiment of a process for providing a data backup service;

FIG. 19, in combination with FIG. 17, is a flow chart of yet another exemplary embodiment of a process for providing a data backup service;

FIG. 20, in combination with FIG. 17, is a flow chart of still another exemplary embodiment of a process for providing a data backup service; and

FIG. 21, in combination with FIG. 17, is a flow chart of still yet another exemplary embodiment of a process for providing a data backup service.

### DESCRIPTION

The following paragraphs include definitions of exemplary terms used within this disclosure. Except where noted otherwise, variants of all terms, including singular forms, plural forms, and other forms, fall within each exemplary term meaning. Except where noted otherwise, capitalized and non-capitalized forms of all terms fall within each meaning.

“Circuit,” as used herein includes, but is not limited to, hardware, firmware, software or combinations of each to perform a function(s) or an action(s). For example, based on a desired feature or need, a circuit may include a software controlled microprocessor, discrete logic such as an application specific integrated circuit (ASIC), or another programmed logic device. A circuit may also be fully embodied as software. Additionally, a circuit may include a sensor, detector, or emitter/detector combination. As used herein, “circuit” may be considered synonymous with “logic.”

“Comprising,” “containing,” “having,” and “including,” as used herein, except where noted otherwise, are synonymous and open-ended. In other words, usage of any of these terms (or variants thereof) does not exclude one or more additional elements or method steps from being added in combination with one or more delineated elements or method steps.

“Computer communication,” as used herein includes, but is not limited to, a communication between two or more computer components and can be, for example, a network transfer, a file transfer, an applet transfer, an e-mail, a hypertext transfer protocol (HTTP) message, a datagram, an object transfer, a binary large object (BLOB) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, any other current or subsequent communication system, and so on.

“Computer component,” as used herein includes, but is not limited to, a computer-related entity, either hardware, firmware, software, a combination thereof, or software in execution. For example, a computer component can be, but is not limited to being, a processor, an object, an executable, a process running on a processor, a thread of execution, a program and a computer. By way of illustration, both an application running on a server and the server can be computer components. One or more computer components can reside within a process or thread of execution and a computer component can be localized on one computer or distributed between two or more computers.

“Controller,” as used herein includes, but is not limited to, any circuit or device that coordinates and controls the operation of one or more input, output, or other types of devices. For example, a controller can include a device having one or more processors, microprocessors, or central processing units (CPUs) capable of being programmed to perform input or output functions.

“Logic,” as used herein includes, but is not limited to, hardware, firmware, software or combinations of each to perform a function(s) or an action(s), or to cause a function or action from another component. For example, based on a desired application or need, logic may include a software controlled microprocessor, discrete logic such as an application specific integrated circuit (ASIC), or other programmed logic device. Logic may also be fully embodied as software. Additionally, a circuit may include a sensor, detector, or emitter/detector combination. As used herein, “logic” may be considered synonymous with “circuit.”

“Operable connection” (or a connection by which entities are “operably connected”), as used herein includes, but is not limited to, a connection in which signals, physical communication flow, or logical communication flow may be sent or received. Usually, an operable connection includes a physical interface, an electrical interface, or a data interface, but an operable connection may include differing combinations of these or other types of connections sufficient to allow operable control.

“Operative communication,” as used herein includes, but is not limited to, a communicative relationship between devices, logic, or circuits, including mechanical and pneumatic relationships. Direct and indirect electrical, electromagnetic, and optical connections are examples of connections that facilitate operative communications. Linkages, gears, chains, belts, push rods, cams, keys, attaching hardware, and other components contributing to mechanical relations between items are examples of components facilitating operative communications. Pneumatic devices and interconnecting pneumatic tubing may also contribute to operative communications. Two devices are in operative communication if an action from one causes an effect in the other, regardless of whether the action is modified by some other device. For example, two devices in operable communication may be separated by one or more of the following: i) amplifiers, ii) filters, iii) transformers, iv) optical isolators, v) digital or analog buffers, vi) analog integrators, vii) other electronic circuitry, viii) fiber optic transceivers, ix) Bluetooth communications links, x) IEEE 802.11 communications links, xi) satellite communication links, and xii) other wireless communication links. As another example, an electromagnetic sensor is in operative communication with a signal if it receives electromagnetic radiation from the signal. As a final example, two devices not directly connected to each other, but both capable of interfacing with a third device, e.g., a central processing unit (CPU), are in operative communication.

“Or,” as used herein, except where noted otherwise, is inclusive, rather than exclusive. In other words, “or’ is used to describe a list of alternative things in which one may choose one option or any combination of alternative options. For example, “A or B” means “A or B or both” and “A, B, or C” means “A, B, or C, in any combination or permutation.” If “or” is used to indicate an exclusive choice of alternatives or if there is any limitation on combinations of alternatives, the list of alternatives specifically indicates that choices are exclusive or that certain combinations are not included. For example, “A or B, but not both” is used to indicate use of an exclusive “or” condition. Similarly, “A, B, or C, but no combinations” and “A, B, or C, but not the combination of A, B, and C” are examples where certain combinations of alternatives are not included in the choices associated with the list.

“Processor,” as used herein includes, but is not limited to, one or more of virtually any number of processor systems or stand-alone processors, such as microprocessors, microcontrollers, central processing units (CPUs), distributed processors, paired processors, and digital signal processors (DSPs), in any combination. The processor may be associated with various other circuits that support operation of the processor, such as random access memory (RAM), read-only memory (ROM), programmable read-only memory (PROM), erasable programmable read-only memory (EPROM), clocks, decoders, memory controllers, or interrupt controllers, etc. These support circuits may be internal or external to the processor or its associated electronic packaging. The support circuits are in operative communication with the processor. The support circuits are not necessarily shown separate from the processor in block diagrams or other drawings.

“Software,” as used herein includes, but is not limited to, one or more computer readable or executable instructions that cause a computer or another electronic device to perform functions, actions, or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system, or other types of executable instructions. It will be appreciated by one of ordinary skill in the art that the form of software is dependent on, for example, requirements of a desired application, the environment it runs on, or the desires of a designer/programmer or the like.

“Software component,” as used herein includes, but is not limited to, a collection of one or more computer readable or executable instructions that cause a computer or other electronic device to perform functions, actions or behave in a desired manner. The instructions may be embodied in various forms like routines, algorithms, modules, methods, threads, or programs. Software components may be implemented in a variety of executable or loadable forms including, but not limited to, a stand-alone program, a servlet, an applet, instructions stored in a memory, and the like. Software components can be embodied in a single computer component or can be distributed between computer components.

The following table includes long form definitions of exemplary acronyms, abbreviations, and labels for variables and constants in mathematical or logical expressions used within this disclosure. Except where noted otherwise, variants of all acronyms, including singular forms, plural forms, and other affixed forms, fall within each exemplary acronym meaning. Except where noted otherwise, capitalized and non-capitalized forms of all acronyms fall within each meaning.

Acronym Long Form

ASIC Application specific integrated circuit

BLOB Binary large object

CPU Central processing unit

DSP Digital signal processor

EPROM Erasable programmable read-only memory

GB Gigabyte

HIPPA Health Insurance Portability and Accountability Act

HTTP Hypertext transfer protocol

Acronym Long Form

IP Internet protocol

LAN Local area network

LS Locator service

MAC Media access control

PROM Programmable read-only memory

RAM Random access memory

ROM Read-only memory

SMB Small or mid-sized business

SQL Standard query language

TB Terabyte

TDAS Trusted device authentication service

WAN Wide area network

The various embodiments of a data backup system and a method associated therewith described herein may eliminate many routine manual interventions of prior data backup techniques by automating the data backup process and the moving of data offsite for disaster recovery purposes. For example, the system may be deployed as a mobile backup appliance (“the appliance”) including hardware and software. The appliance may be portable and transportable. For example, the enclosure for the appliance may have a form factor similar to a briefcase. In one embodiment, the appliance may include a rack-mounted enclosure. In another embodiment, the application may include a cube-shaped enclosure. In one embodiment, the appliance may utilize an operating system (e.g., Linux) and may include a storage device (e.g., hard drive) for storage of the operating system, software applications, and data.

The appliance may also include a communications port (e.g., an Ethernet port) for connection to a LAN or internet (e.g., the Internet). Client software may be deployed to manage data backup and recovery operations. The client software may be deployed to any computer for which files on an associated storage device may be desired to be backed up. The data backup client, for example, may include a user interface and an agent software component. The user interface, for example, may be Web-based (e.g., Web pages operated using a standard Web browser). Notably, the data backup client does not require a user interface. Therefore, the terms client and agent are understood to be interchangeable as used in this description unless the use is specifically identified to only relate to a client or an agent.

After an initial full backup of a data source (e.g., one or more desktop computers, one or more laptop computers, or one or more servers in any combination) the appliance may be moved offsite to any location (e.g. the residence of a trusted officer or administrator) with access to a suitable communication network (e.g., broadband Internet service) that is also accessible to Agent software within the data source (e.g., office computer or network). The appliance may communicate with the data source over the communication network (e.g., an internet protocol (IP) connection) and may perform incremental backups of the data source on a scheduled basis. In case of loss of data on the data source, the appliance may be accessed for data recovery. For example, in one embodiment, a method of backing up data may include coupling an appliance to a data source and making an initial backup, moving the appliance offsite and connecting to the data source via the internet, using a locator service to maintain address information of the appliance, and periodically updating the backup via the internet connection to the data source. In this embodiment, the appliance is mobile. Thus, address information may vary or change as the appliance is disconnected and re-connected to the system at a different connection point on the same network or on a different network.

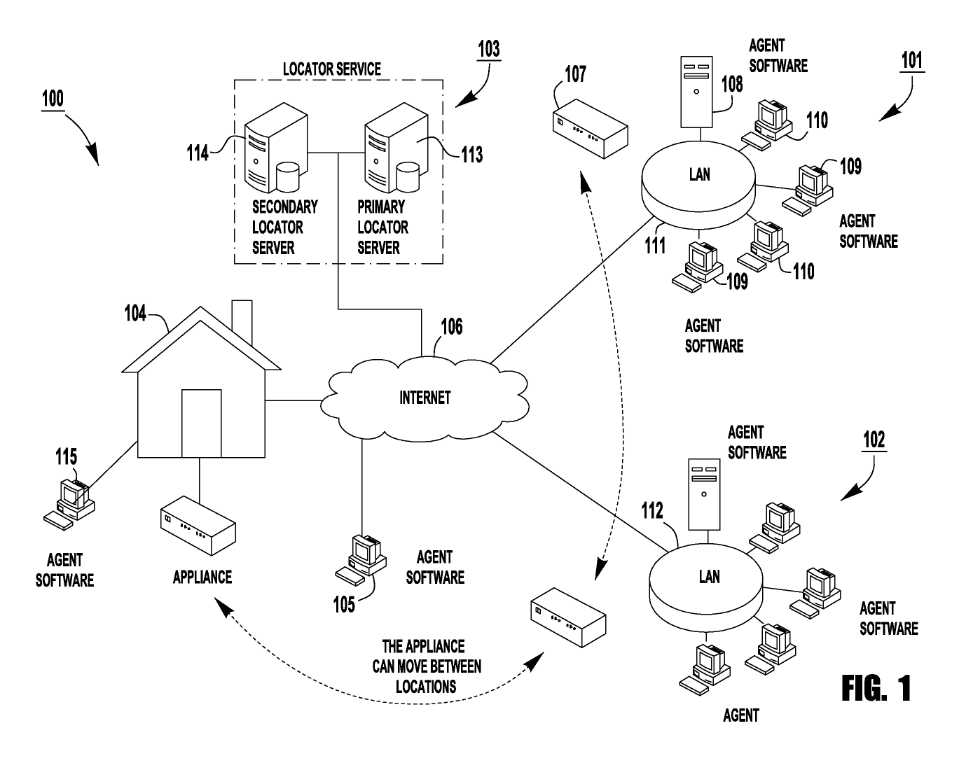

With reference to FIG. 1, an exemplary embodiment of a data backup system 100 may include a first computer network 101, a second computer network 102, a locator service 103, a remote backup site 104, and a computer 105 with a data backup agent (or client) interconnected via a communication network (e.g., the Internet) 106. The communication network may include networks utilizing various technologies (e.g., wired and wireless LAN, wired and wireless WAN, landline and wireless telephone, cable and satellite television, other forms of satellite communication, and other suitable communication technologies) in any combination. The data backup system 100 may also include a mobile backup appliance 107.

The first computer network 101 may include a server 108 with a data backup agent (or client), a plurality of computers 109 with data backup agents (or clients), and a plurality of additional computers 110 interconnected via a LAN 111. The second computer network 102 may include a plurality of devices interconnected via a LAN 112 in a configuration similar to that of the first computer network 101 or in an alternate configuration. The locator service 103 may include a primary locator service server 113 and a secondary locator server 114. The data backup site 104 may include a computer 115 with a data backup agent (or client). For example, the data backup appliance 107 may be moved to any location within any network or internet in the data backup system 100, such as within the first computer network 101, within the second computer network 102, or to the remote backup site 104.

The backup appliance 107 may be directly coupled to the first or second computer networks 101, 102 to make an initial backup of storage devices attached to the corresponding network. Although two exemplary networks are shown by way of example, the data backup system 100 may include any number of networks (i.e., one to many) in any suitable configuration. A network with at least one storage devices storing at least one file to be backed up includes agent software as shown for servers 108 and computers 109 of the first and second computer networks 101, 102. The backup appliance 107 may be stored offsite at any location, such as at the remote backup site 104. The computer 115 at the remote backup site 104 may run the agent software for backing up files stored on storage devices associated with the computer 115. The backup appliance 107 may connect to the first or second computer network 101, 102 via the communication network 106. The locator service 103 may maintain information indicating the last known location of the backup appliance 107 so that agent software at various devices may locate the backup appliance 107 (e.g., establish a communication path with the backup appliance).

To initiate the data backup, the backup appliance 107 may be brought onsite and connected to a computer network (e.g. 101) via a LAN (e.g., 111) like any other computer device (e.g. 108, 109, 110). Agent software may be installed on any servers, desktop computers, or laptop computers of the computer network that store files that may be desired to be backed up. In this configuration, select files may be backed up at the transfer speeds of the corresponding computer devices and LAN. After this initial backup (also known as a “seed” backup) is complete, the backup appliance 107 may be disconnected from the LAN and moved to an offsite location (e.g., remote backup site 104) such as a remote office or an owner's house. The backup appliance 107 at the offsite location may be interconnected to the computer network (e.g., 101) via a communication network (e.g., 106). Preferably, communication paths from the offsite location to the computer network support high speed communications (e.g., broadband communications).

Once the backup appliance 107 is connected to the communication network (e.g., 106), it may transmit address information regarding its identification and location (e.g., IP address, media access control (MAC) address, port number, system tag, and Trusted Device Authentication Service (TDAS) signature) to the primary or secondary locator servers 113, 114. As used in this description, “address information” may include IP address, MAC address, port number, system tag, TDAS signature, public address, private address, hardware signature, or any other information suitable for identifying or locating the backup appliance. The address information may be dated and cataloged on the primary and secondary locator servers 113, 114 for future reference. A successful communication between the backup appliance 107 and locator service 103 may include a security check to confirm that data backups to the backup appliance 107 are authorized and an authentication check to confirm the identity of the backup appliance 107 transmitting address information.

The agent software may find a connected backup appliance 107 anywhere in the data backup system 100 through predetermined process. For example, agent software may first try to communicate with the backup appliance 107 using the IP address for the last successful connection. If the backup appliance 107 is not found at its last known IP address, the agent software may use a network discovery process to find the backup appliance 107 in its closest network neighborhood (e.g., LAN/WAN). If the network discovery process fails, the agent software may connect to the communication network 106 and request address information from the locator service 103. If communication with the primary locator service server 113 fails, the agent software may attempt to communicate with the secondary locator service server 114. Upon successful communication with either the primary or secondary locator service servers 113, 114, the agent software may receive address information for the backup appliance 107. A successful communication between the agent software and locator service 103 may include a security check to confirm that the agent software is authorized to perform backups to the backup appliance 107 and an authentication check to confirm the identity of the agent software requesting address information.

The locator service (LS) 103 may provide identification and location information and TDAS for the backup appliance 107. The LS 103 may also supply the agent software with the last IP address, MAC address, port number, and hardware serial number (i.e., system tag number) reported by the backup appliance 107. The identification and location information may be time-stamped. This identification and location information may be encrypted during transmission over the public or private networks.

The backup appliance 107 maintains a series of fully-recoverable, point-in-time backups for files stored on a storage device through communications with corresponding agent software on an associated computer device (e.g., 105, 108, 109, 115). Various algorithms (e.g., de-duplication logic, delta logic, etc.) may reduce the bandwidth consumed to deliver this backup capability. Backed up data can be restored using the agent software regardless of where the backup appliance is connected to the data backup system 100. For example, the backup appliance 107 can be transported to an office and connected to the LAN (e.g., 111) where the storage device is connected to restore files at transfer speeds of the corresponding computer devices and LAN. Alternatively, the backup appliance 107 can be transported to a secondary location in operative communication with the storage device via a communication network (e.g., 106) to restore files at the transfer speed of the corresponding computer devices and communication network. Generally, the backup appliance 107 may be transported to a desired location and connected to a desired network for backup or restore operations based on transfer speed, reliability, and cost considerations. For example, when a third of businesses tell CIO Magazine that the cost of downtime is over $10,000 per hour and another 42% value their downtime at $1,000 to $9,999 per hour, the value of speed and convenience is quickly realized.

In one embodiment, the data backup system 100 may be an all-inclusive appliance that delivers the advantages of high end backup services at costs comparable to in-house tape backup systems. Once an agent is installed, an automated backup of select files from storage devices associated with the corresponding computer device (e.g., desktop computer, laptop computer, server, etc.) A laptop computer, for example, will not need a separate solution if it is transported to a remote office or to another off-site location. For example, a small or mid-sized business (SMB) can contract for remote management and monitoring services through a service provider (e.g., manufacturer, distributor, etc.). If the backup appliance 107 is owned by the SMB, recurring costs may be limited to these optional monitoring, extended warranty, and support service packages. This may cost less than full vaulting operations. In this business model, the data backup system 100 not only serves the need of the SMB customer, but also generates value for the service provider. Service providers used to selling a backup solution with each server replacement (e.g., 5 year cycle) can generate incremental sales by replacing data backup systems for existing customers dissatisfied with their current solution. Additionally, the ability to remotely configure, manage, and restore may reduce the costs of delivering standard service and maintenance packages.

In one embodiment, the backup appliance 107 may protect between 200 gigabyte (GB) and 3 terabyte (TB) of data. This embodiment maybe capable of backing up as many as a dozen servers and several hundred desktops, including standard query language (SQL) databases and Microsoft Exchange. For example, as long as the backup appliance 107 is connected to the Internet through a broadband connection, it can be accessed and operated like a vaulting service. All backup up data on the backup appliance 107 may remain encrypted (e.g., complying with Health Insurance Portability and Accountability Act (HIPPA) standards). In one embodiment, backup storage devices in the backup appliance 107 may include hard disk drives. In this embodiment, there is no need to handle or manage tapes or other types of removable media during backup or restore processes. In other embodiments, the backup storage devices in the backup appliance 107 may include any combination of tape drives, removable disk drives, removable memory devices, etc. The backup appliance 107 may include any suitable combination of off the shelf hardware and a Linux operating system. The data backup system 100 may include logic for block level backup, common file elimination, compression, and encryption. The data backup system 100 may include a centralized system that notifies SMB's, for example, of any anomalies on the communication link and the health of the system.

The data backup system 100 may be provided in a turnkey solution. Rather then trying to wrap a web interface around an offline solution, creating complexity, the data backup system 100 may be built and optimized for the web. This means that the whole data backup system 100, from backup protocol to remote management interface, may be designed to perform properly across the Internet and by “starting from scratch” the backup system 100 may include various combinations of algorithms, processes, and logic. The data backup system 100 has little in common with existing tape and disk-to-disk backup solutions.

When the backup data system 100 is initially purchased, the “briefcase” shaped backup appliance 107 can be brought on site to backup files at transfer speeds of the corresponding computer devices and LAN. This may provide an initial backup faster than backup systems at off-site or remote location that cannot be directly connected to the LAN. For example, a user need only log onto a service provider website, enter the correct credentials, download the agent, and complete a quick installation wizard to backup files associated with the corresponding computer. Once the data backup system 100 is installed, the backup appliance 107 and the installed agents may communicate with each other, for example, via the Internet using the locator service 103 to complete scheduled backups and any day-to-day recovery activity. If a major failure (i.e., loss of data) occurs, business downtime can be reduced by bringing the backup appliance 107 back to the office to recover lost or damaged files at faster transfer speeds.

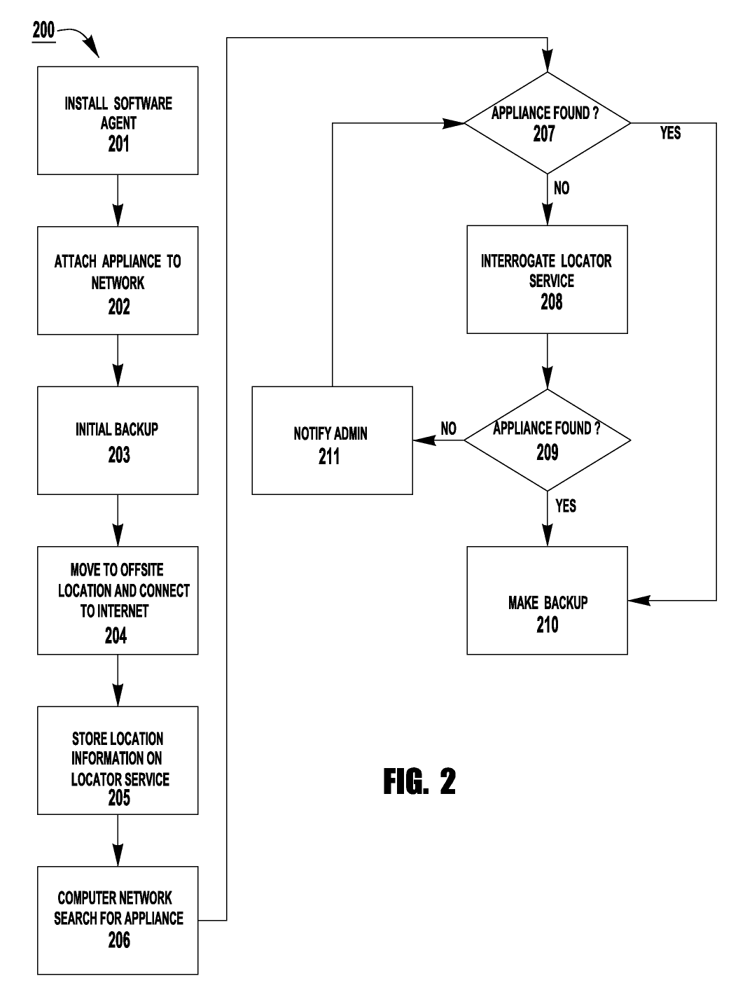

With reference to FIG. 2, an exemplary embodiment of a process 200 for providing a data backup service may begin at 201 where agent software may be installed in one or more computing devices on the computer network having at least one storage device with files to be protected. At 202, the backup appliance may be attached to the network. At 203, the initial backup (i.e., “seed backup) may be performed. At 204, the backup appliance may be moved offsite and coupled, for example, to a communication network (e.g., the Internet) via, for example, a broadband connection. At 205, location information about the backup appliance may be detected and stored in the locator service.

At 206, one or more agents associated with the protected computer network may search for the backup appliance. At decision block 207, the process may determine if the backup appliance is found at a recent known address or at another address on the LAN/WAN network. If not, the locator service may be interrogated at 208 in order to find the backup appliance. At decision block 209, the process may determine if the backup appliance is found using address information from the locator service. If found at 207 or 209, the data backup system proceeds with a new backup at 210. If the backup appliance is not found at 209, an administrator is notified at 211 so that appropriate action can be taken. The process is then passed to block 207 for more trials to find the appliance.

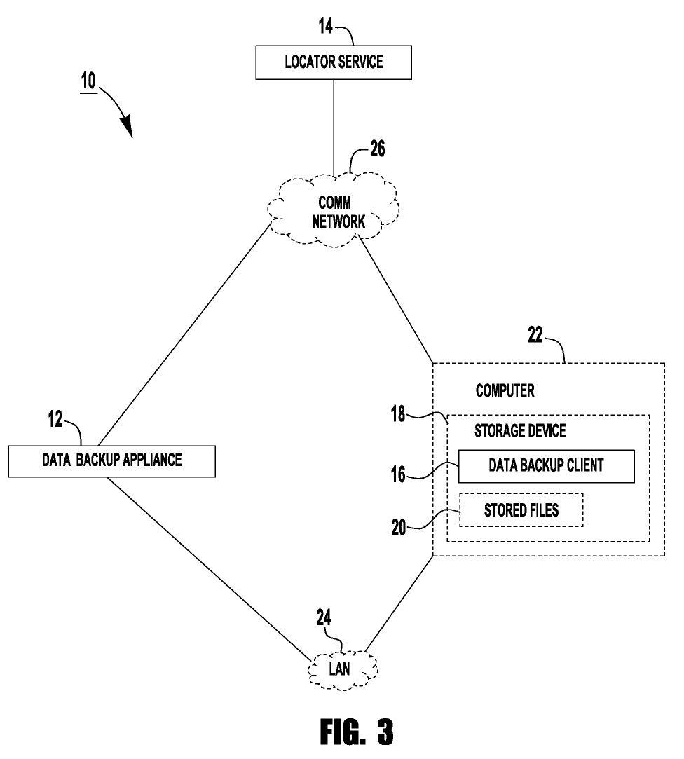

With reference to FIG. 3, an exemplary embodiment of a data backup system 10 may include a data backup appliance 12, a locator service 14, and a data backup client 16. The data backup appliance 12 may at least initially be located at a first device address in operative communication with at least one storage device (e.g., 18) storing a plurality of files 20. As shown, the data backup appliance 12 and a computer 22 associated with the storage device 18 may be in operative communication via the LAN 24. The exemplary storage device 18 is depicted internal to the computer. However, external storage devices and storage devices accessible to the computer 22 via networks, such as the LAN 24 or communication network 26, are also considered associated with the computer 22 in other embodiments of the data backup system 10. The computer 22 may include a desktop computer, laptop computer, server, and any other suitable type of computer device. The LAN 24 may be wired, wireless, or combinations thereof.

The communication network 26 may include one or more networks utilizing any combination of various technologies (e.g., wired and wireless LAN, wired and wireless WAN, landline and wireless telephone, cable and satellite television, other forms of satellite communication, and other suitable communication technologies). As shown, the data backup appliance 12 may also initially be in operative communication with the locator service 14 via the communication network 26. From the communication network 26, the data backup appliance 12 may also be located via a second device address. In the embodiment being described, the first device address may be referred to as a private address and the second device address may be referred to as a public address. In other embodiments, the data backup appliance 12 may initially connected to the LAN 24, but not the communication network 26. For example, after an initial period (e.g., after an initial backup operation), the data backup appliance 12 may be disconnected from the LAN 24 and connected to the communication network 26 for routine delta backup operations.

The locator service 14 may maintain address information for the data backup appliance 12 at least after address information for the data backup appliance 12 is different from corresponding information associated with the first device address. The address information may include IP address, MAC address, port number, system tag, TDAS signature, public address, private address, hardware signature, or any other information suitable for identifying or locating the data backup appliance 12. For example, if the data backup appliance 12 is disconnected from the LAN 24 and connected to another network, the data backup appliance 12 may transmit address information to the locator service 14. The locator service 14 may store (i.e., maintain) address information for the data backup appliance 12 after this re-connection. The locator service 14 may also store (i.e., maintain) address information for the data backup appliance 12 for the initial connection.

The data backup client 16 may be operative communication with the data backup appliance 12 via the LAN 24 and the locator service 14 via the communication network 16. The data backup client 16 may specify one or more files from the stored files 20 on the at least one storage device (e.g., 18) for backup to the data backup appliance 12. The data backup client 16 may locate the data backup appliance 12 at the first device address. For example, with the data backup appliance 12 and computer 22 connected to the LAN 24, the data backup client 16 may locate the data backup appliance 12 using a broadcast request. The data backup client 16 may back up the one or more specified files to the data backup appliance 12 at the first device address. This backup, for example, could be the initial backup operation. The data backup client 16 may retrieve address information for the data backup appliance 12 from the locator service 14 indicating the data backup appliance is identified by a second device address different from the first device address. The different device address, for example, may be due to moving the data backup appliance 12 to a different connection within the data backup system 10 or simply due to change the address assigned to the current connection. The data backup client 16 may back up at least one data portion of the one or more specified files to the data backup appliance 12 at the second device address. This backup, for example, could be a delta backup operation. If file blocking is implemented, for example, the data backup client can identify individual portions (e.g., individual blocks) of files that have changed since the last backup. Thus, if only a one block of one file has changed, an instance of a delta backup operation could simply backup the corresponding changed block and proceed to a shutdown or sleep mode. Alternatively, the delta backup operation could simply backup the corresponding file associated with the changed block. Even if file blocking is not used, a delta backup operation could be limited to backing up a single file if that is the only file that has changed since the last backup.

With reference to FIG. 4, an exemplary embodiment of a data backup appliance 12 may include a security check logic 28, an authentication logic 29, and a communication logic 30 in any combination. The communication logic 30 may transmit address information to the locator service 14. The communication logic 30 may also receive a request to back up one or more select files stored on the at least one storage device (e.g., 18) from a data backup client (e.g., 16). The security check logic 28 may perform a security check to confirm data backups from the at least one storage device (e.g., 18) to the data backup appliance 12 are authorized. The authentication logic may perform an authentication check to confirm an identity of a computer device (e.g., 22) from which any request to back up the one or more files received by the communication logic 30 was sent.

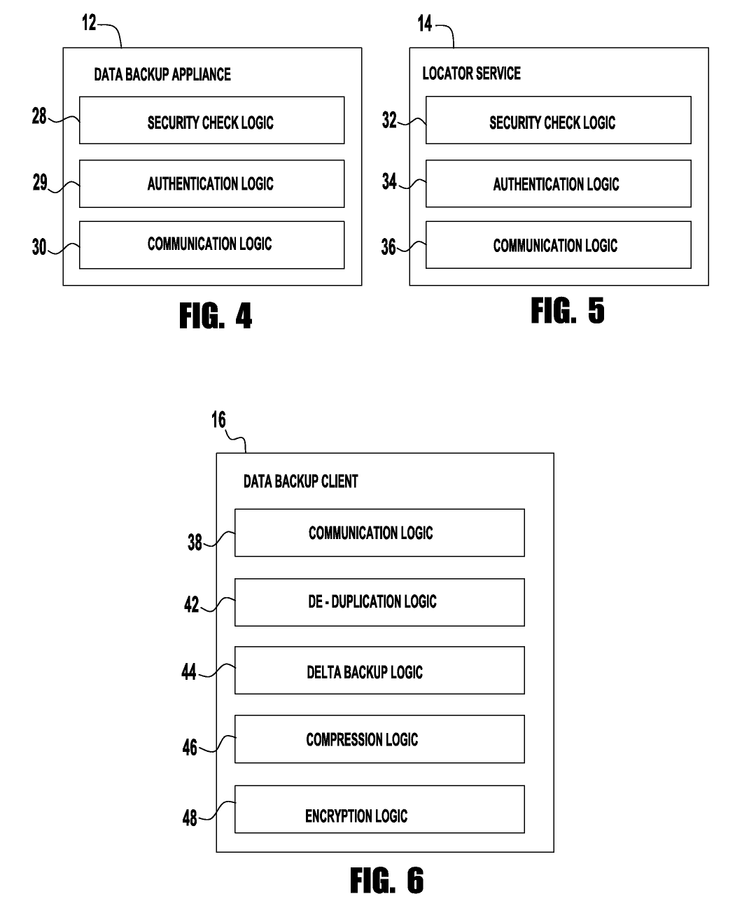

With reference to FIG. 5, an exemplary embodiment of a locator service 14 may include a security check logic 32, an authentication logic 34, and a communication logic 36 in any combination. The communication logic 36 may receive address information for the data backup appliance 12. The communication logic 36 may also receive a request for address information associated with the data backup appliance from a data backup client (e.g., 16). The security check logic 32 may perform a security check to confirm data backups to the data backup appliance 12 associated with address information received by the communication logic 36 are authorized. The security check logic 32 may also perform a security check to confirm data backups from a storage device (e.g., 18) to the data backup appliance associated with the request for address information received by the communication logic 36 are authorized. The authentication logic 34 may perform an authentication check to confirm address information received by the communication logic 36 was sent by the data backup appliance 12. The authentication logic 34 may also perform an authentication check to confirm an identity of a computer device (e.g., 22) from which any request for address information associated with the data backup appliance 12 received by the communication logic 36 was transmitted.

With reference to FIG. 6, an exemplary embodiment of a data backup client may include a communication logic 38, a de-duplication logic 42, a delta backup logic 44, a compression logic 46, and an encryption logic 48 in any combination. The communication logic 38 may broadcast a request to back up at least one portion of one or more specified files to the data backup appliance 12 over the LAN 24. If the data backup appliance 12 is connected to the LAN 24, the communication logic 38 may receive a response to the request. The communication logic 38 may also determine the data backup appliance 12 is not connected to the LAN 24 based at least in part on not receiving a response to the request. The communication logic 38 may also transmit a request for address information for the data backup appliance 12 to the locator service 14 over the communication network 26. If the locator service 14 is connected to the communication network 26 and the data backup appliance 12 is connected to the data backup system 10 and has transmitted address information to the locator service 14, the communication logic 38 may receive address information from the locator service 14 in response to a request for such information. The compression logic 46 may compress files to be backed up to the data backup appliance 12 and portions of files to be backed up to the data backup appliance 12 prior to the backing up. The encryption logic 48 may encrypt files to be backed up to the data backup appliance 12 and portions of files to be backed up to the data backup appliance 12 prior to the backing up.

In one embodiment, the delta backup logic 44 may divide a first stored file from the at least one storage device (e.g., 18) into a plurality of data blocks and a second stored file from the at least one storage device (e.g., 18) into a plurality of data blocks. In the embodiment being described, the de-duplication logic 42 may back up the first stored file to the data backup appliance 12 at the first device address by backing up each of the plurality of data blocks, determine at least one data block of the second stored file is a duplicate of a corresponding data block in the first stored file, back up the second stored file to the data backup appliance 12 at the first device address using at least one pointer to reference each duplicate data block of the second stored file to the corresponding data block in the first stored file. In another embodiment, the de-duplication logic 42 may determine the second stored file from the at least one storage device (e.g., 18) is a duplicate of the first stored file and back up the second stored file to the data backup appliance at the first device address using at least one pointer to reference the first stored file.

In another embodiment, the delta backup logic 44 may divide at least one file to be backed up to the data backup appliance 12 into a plurality of data blocks and determine at least one data block of at least one file backed up to the data backup appliance is different than a last time each corresponding data block was backed up. In still another embodiment, the delta backup logic 44 may determine at least one file backed up to the data backup appliance is different than a last time each corresponding file was backed up. The delta backup logic 44 may also recognize failure of the backing up of files or portions of files to the data backup appliance 12.

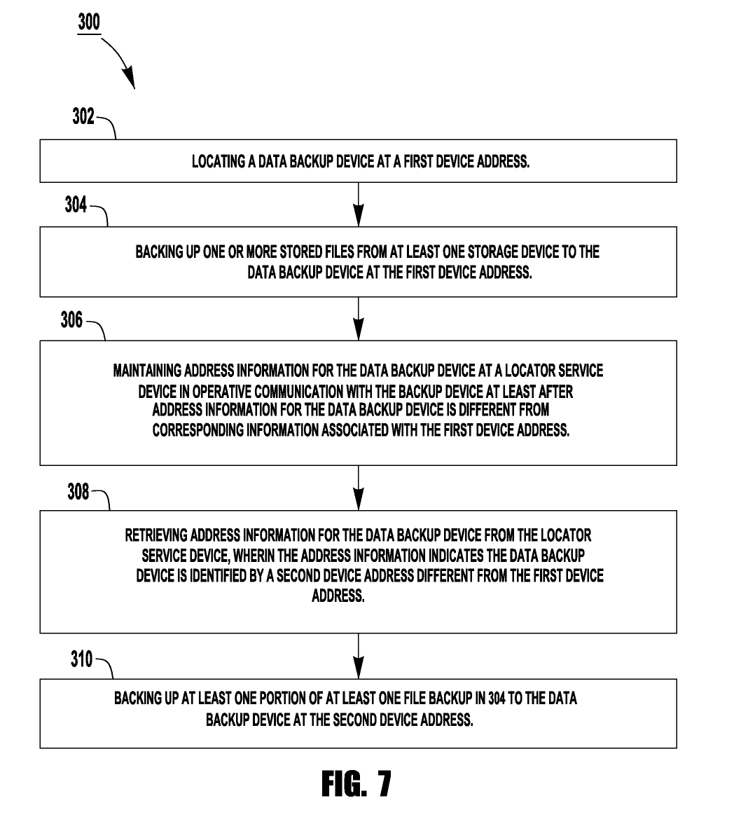

With reference to FIG. 7, an exemplary embodiment of a process 300 for providing a data backup service may begin at 302 where a data backup device is located at a first device address. At 304, one or more stored files from at least one storage device may be backed up to the data backup device at the first device address. Next, address information for the data backup device may be maintained at a locator service device in operative communication with the data backup device at least after address information for the data backup device is different from corresponding information associated with the first device address (306). At 308, address information for the data backup device may be retrieved from the locator service device. The address information may indicate the data backup device is identified by a second device address different from the first device address. Next, at least one portion of at least one file backed up in 304 may be backed up to the data backup device at the second device address.

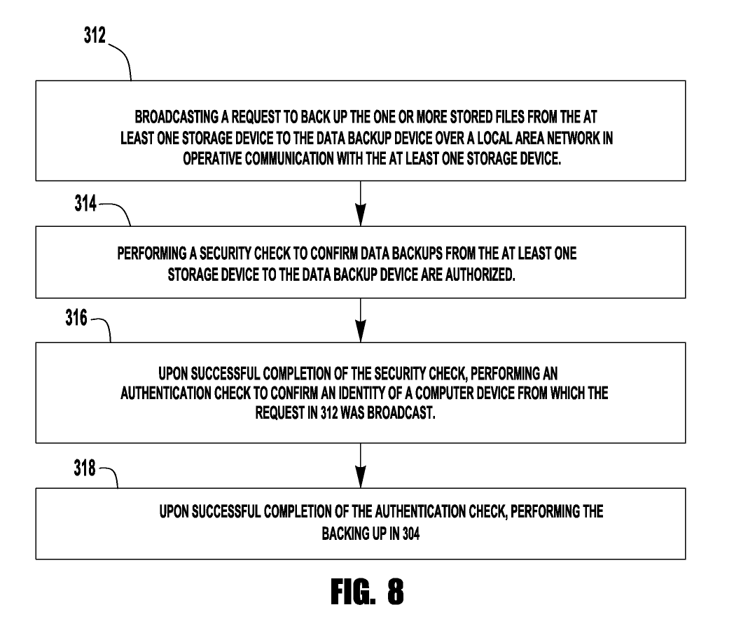

With reference to FIGS. 7 and 8, another exemplary embodiment of a process 300 for providing a data backup service may also include broadcasting a request to back up the one or more stored files from the at least one storage device to the data backup device over a local area network in operative communication with the at least one storage device (312). At 314, a security check may be performed to confirm data backups from the at least one storage device to the data backup device are authorized. Next, upon successful completion of the security check, an authentication check may be performed to confirm an identity of a computer device from which the request in 312 was broadcast. At 318, upon successful completion of the authentication check, the backing up in 304 may be performed.

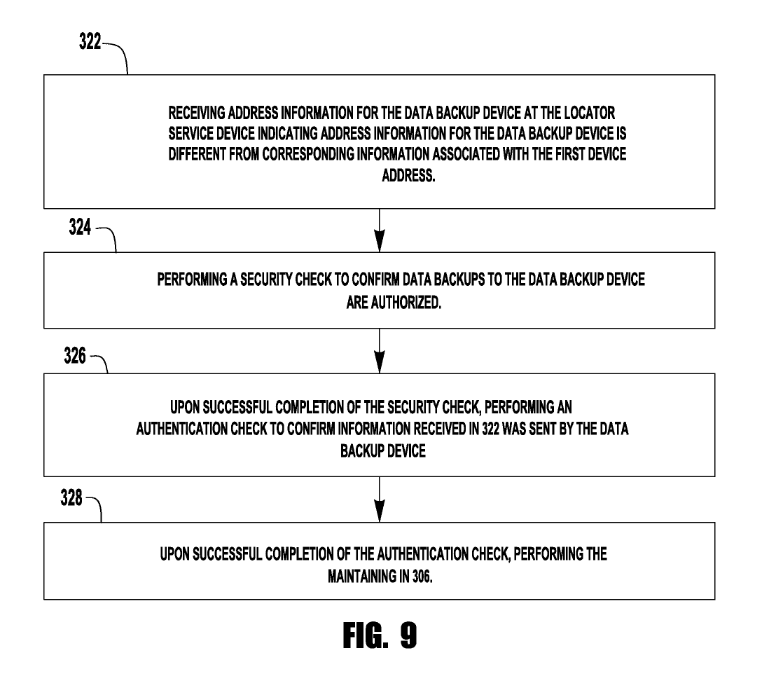

With reference to FIGS. 7 and 9, yet another exemplary embodiment of a process 300 for providing a data backup service may also include receiving address information for the data backup device at the locator service device indicating address information for the data backup device is different from corresponding information associated with the first device address (322). At 324, a security check may be performed to confirm data backups to the data backup device are authorized. Next, upon successful completion of the security check, an authentication check may be performed to confirm information received in 322 was sent by the data backup device (326). At 328, upon successful completion of the authentication check, the maintaining in 306 may be performed.

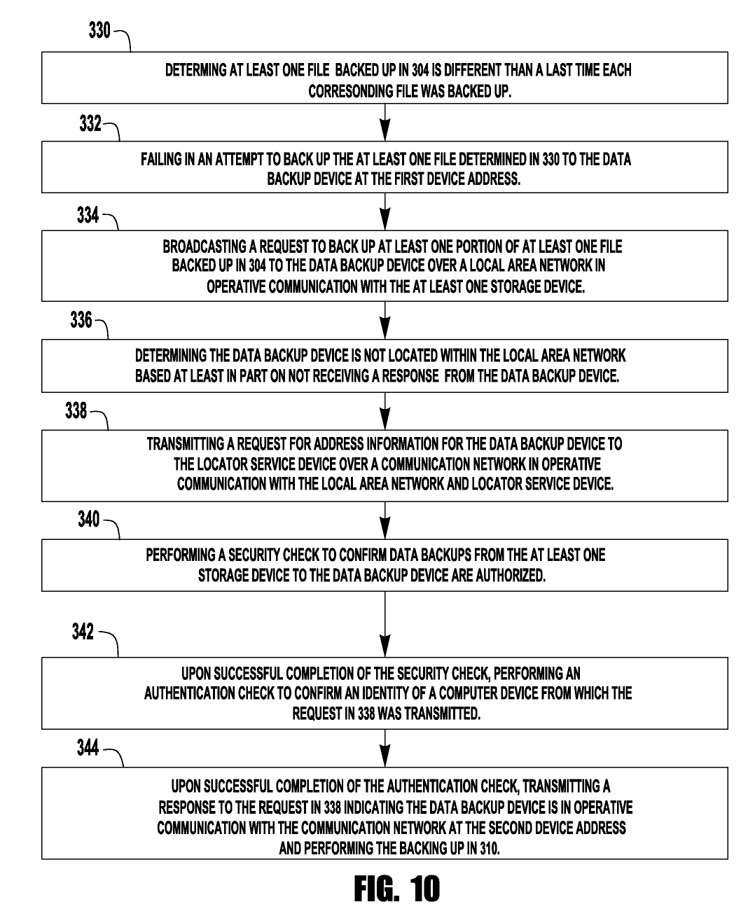

With reference to FIGS. 7 and 10, still another exemplary embodiment of a process 300 for providing a data backup service may also include determining at least one file backed up in 304 is different than a last time each corresponding file was backed up (330). At 332, the process may fail in an attempt to back up the at least one file determined in 330 to the data backup device at the first device address. Next, a request to back up at least one portion of at least one file backed up in 304 may be broadcast to the data backup device over a local area network in operative communication with the at least one storage device (334). At 336, the process may determine the data backup device is not located within the local area network based at least in part on not receiving a response from the data backup device.

Next, a request for address information for the data backup device may be transmitted to the locator service device over a communication network in operative communication the local area network and locator service device (338). At 340, a security check may be performed to confirm data backups from the at least one storage device to the data backup device are authorized. Next, upon successful completion of the security check, an authentication check may be performed to confirm an identity of a computer device from which the request in 338 was transmitted (342). At 344, upon successful completion of the authentication check, a response to the request in 338 indicating the data backup device is in operative communication with the communication network at the second device address may be transmitted and the backing up in 310 may be performed.

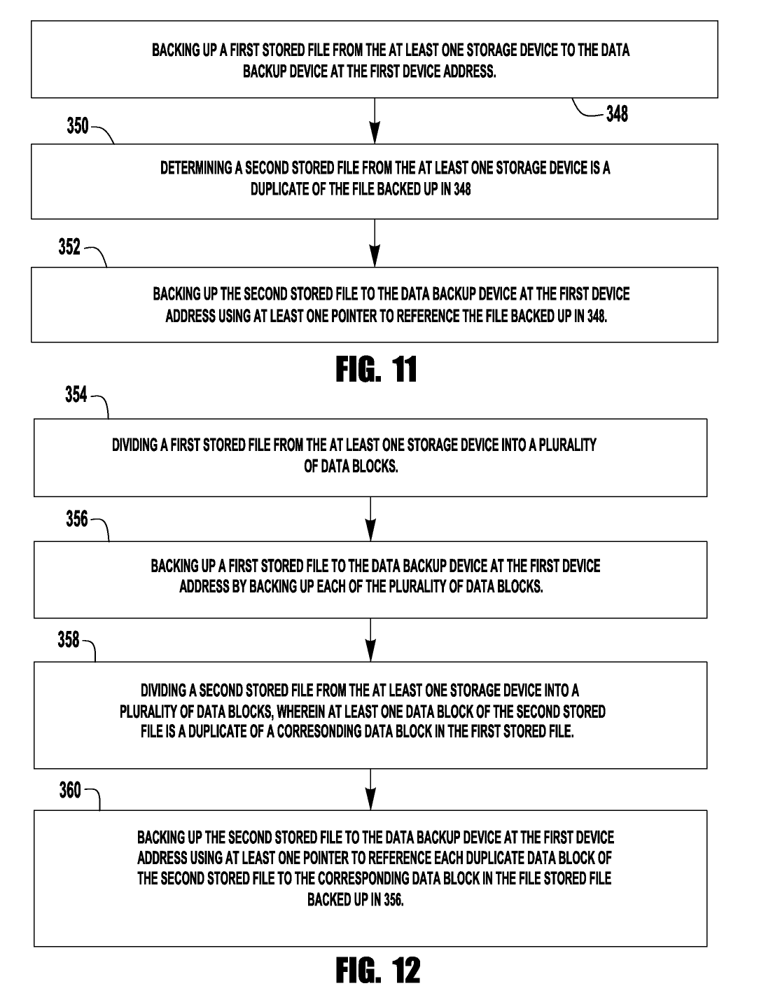

With reference to FIGS. 7 and 11, still yet another exemplary embodiment of a process 300 for providing a data backup service may also include backing up a first stored file from the at least one storage device to the data backup device at the first device address (348). At 350, the process may determine a second stored file from the at least one storage device is a duplicate of the file backed up in 348. Next, the second stored file may be backed up to the data backup device at the first device address using at least one pointer to reference the file backed up in 348.

With reference to FIGS. 7 and 12, another exemplary embodiment of a process 300 for providing a data backup service may also include dividing a first stored file from the at least one storage device into a plurality of data blocks (354). At 356, a first stored file may be backed up to the data backup device at the first device address by backing up each of the plurality of data blocks. Next, a second stored file from the at least one storage device may be divided into a plurality of data blocks (358). At least one data block of the second stored file may be a duplicate of a corresponding data block in the first stored file. At 360, the second stored file may be backed up to the data backup device at the first device address using at least one pointer to reference each duplicate data block of the second stored file to the corresponding data block in the file stored file backed up in 356.

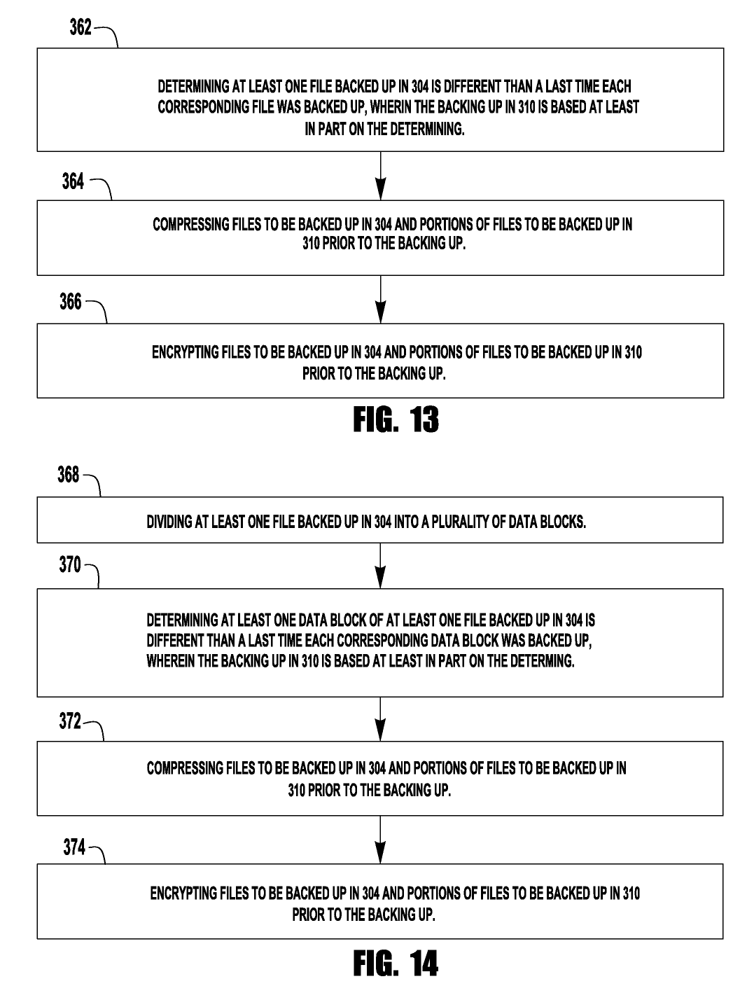

With reference to FIGS. 7 and 13, yet another exemplary embodiment of a process 300 for providing a data backup service may also include determining at least one file backed up in 304 is different than a last time each corresponding file was backed up (362). The backing up in 310 may be based at least in part on the determining in 362. At 364, files to be backed up in 304 and portions of files to be backed up in 310 may be compressed prior to the backing up. Next, files to be backed up in 304 and portions of files to be backed up in 310 may be encrypted prior to the backing up.

With reference to FIGS. 7 and 14, still another exemplary embodiment of a process 300 for providing a data backup service may also include dividing at least one file backed up in 304 into a plurality of data blocks (368). At 370, the process may determine at least one data block of at least one file backed up in 304 is different than a last time each corresponding data block was backed up. The backing up in 310 may be based at least in part on the determining in 370. Next, files to be backed up in 304 and portions of files to be backed up in 310 may be compressed prior to the backing up (372). At 374, files to be backed up in 304 and portions of files to be backed up in 310 may be encrypted prior to the backing up.

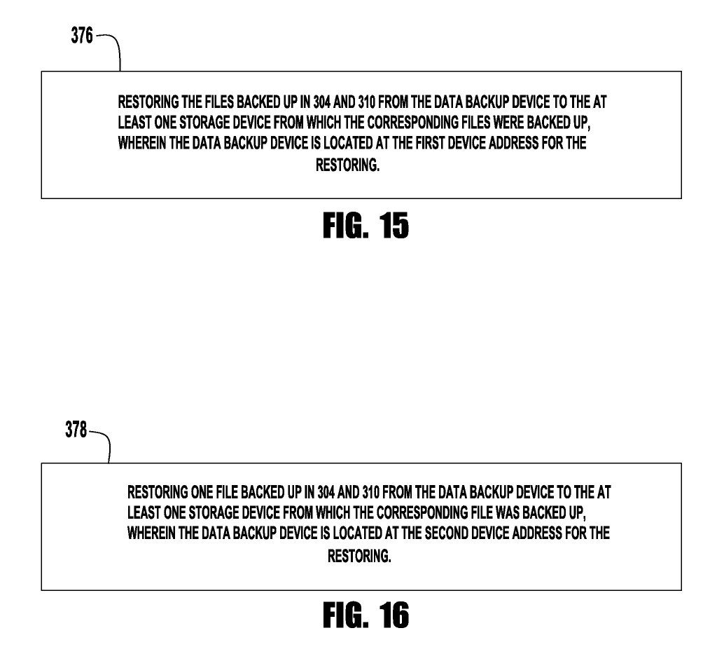

With reference to FIGS. 7 and 15, still yet another exemplary embodiment of a process 300 for providing a data backup service may also include restoring the files backed up in 304 and 310 from the data backup device to the at least one storage device from which the corresponding files were backed up, wherein the data backup device is located at the first device address for the restoring (376).

With reference to FIGS. 7 and 16, another exemplary embodiment of a process 300 for providing a data backup service may also include restoring one file backed up in 304 and 310 from the data backup device to the at least one storage device from which the corresponding file was backed up, wherein the data backup device is located at the second device address for the restoring (378).

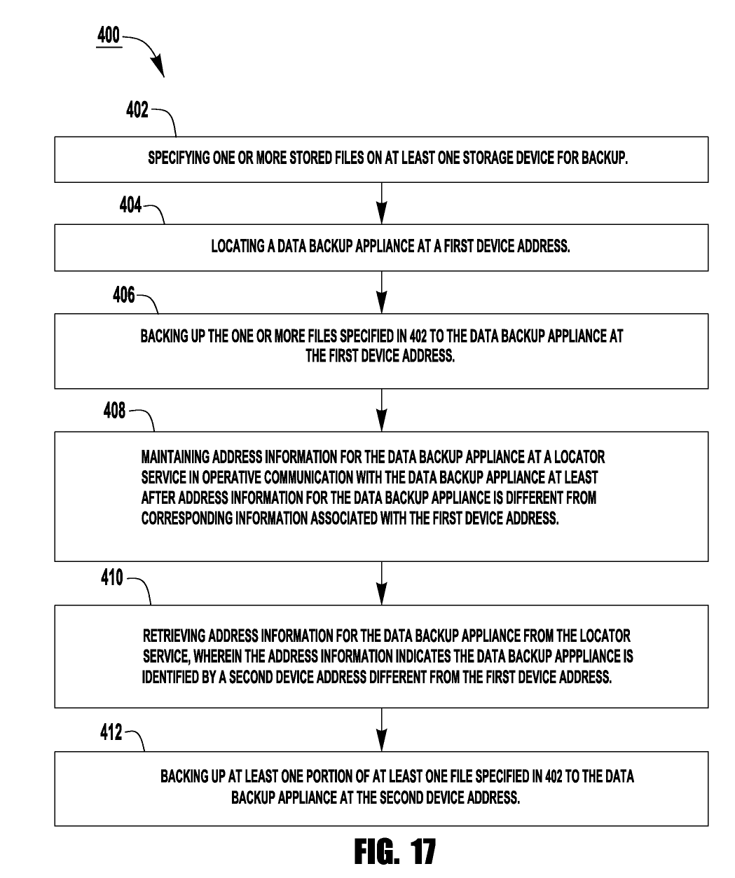

With reference to FIG. 17, yet another exemplary embodiment of a process 400 for providing a data backup service may begin a 402 where one or more stored files on at least one storage device may be specified for backup. At 404, a data backup appliance may be located at a first device address. Next, one or more files specified in 402 may be backed up to the data backup appliance at the first device address (406). At 408, address information for the data backup appliance may be maintained at a locator service in operative communication with the data backup appliance at least after address information for the data backup appliance is different from corresponding information associated with the first device address. Next, address information for the data backup appliance may be retrieved from the locator service (410). The address information may indicate the data backup appliance is identified by a second device address different from the first device address. At 412, at least one portion of at least one file specified in 402 may be backed up to the data backup appliance at the second device address.

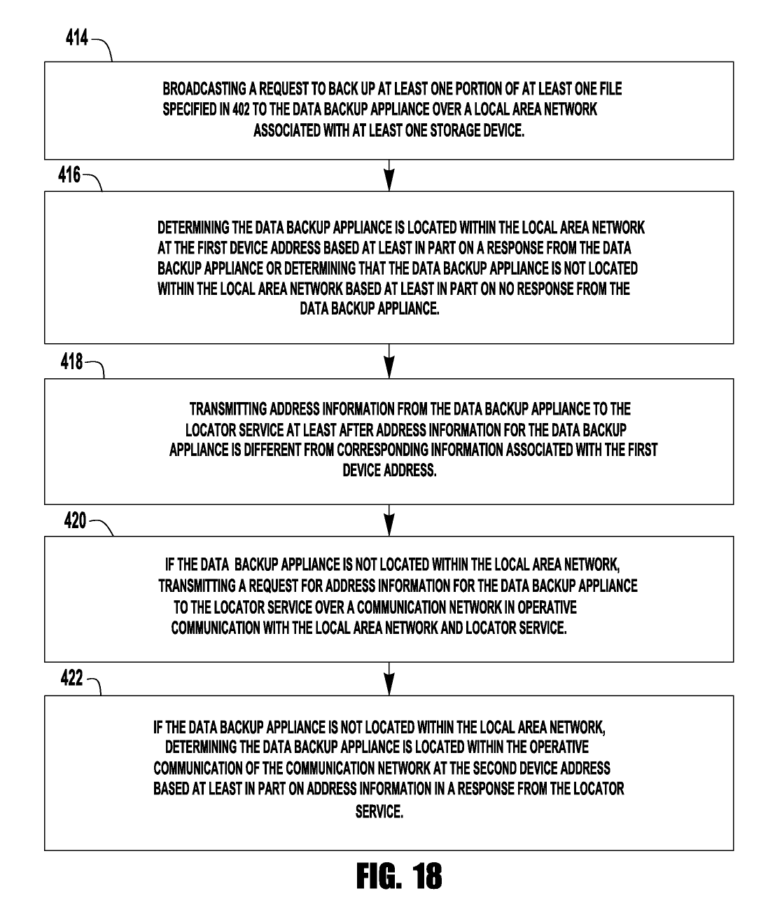

With reference to FIGS. 17 and 18, another exemplary embodiment of a process 400 for providing a data backup service may also include broadcasting a request to back up at least one portion of at least one file specified in a) to the data backup appliance over a local area network associated with the at least one storage device (414). At 416, the process may determine the data backup appliance is located within the local area network at the first device address based at least in part on a response from the data backup appliance or determining that the data backup appliance is not located within the local area network based at least in part on no response from the data backup appliance. Next, address information may be transmitted from the data backup appliance to the locator service at least after address information for the data backup appliance is different from corresponding information associated with the first device address (418). At 420, if the data backup appliance is not located within the local area network, a request for address information for the data backup appliance may be transmitted to the locator service over a communication network in operative communication the local area network and locator service. Next, if the data backup appliance is not located within the local area network, the process may determine the data backup appliance is located within operative communication of the communication network at the second device address based at least in part on address information in a response from the locator service (422).

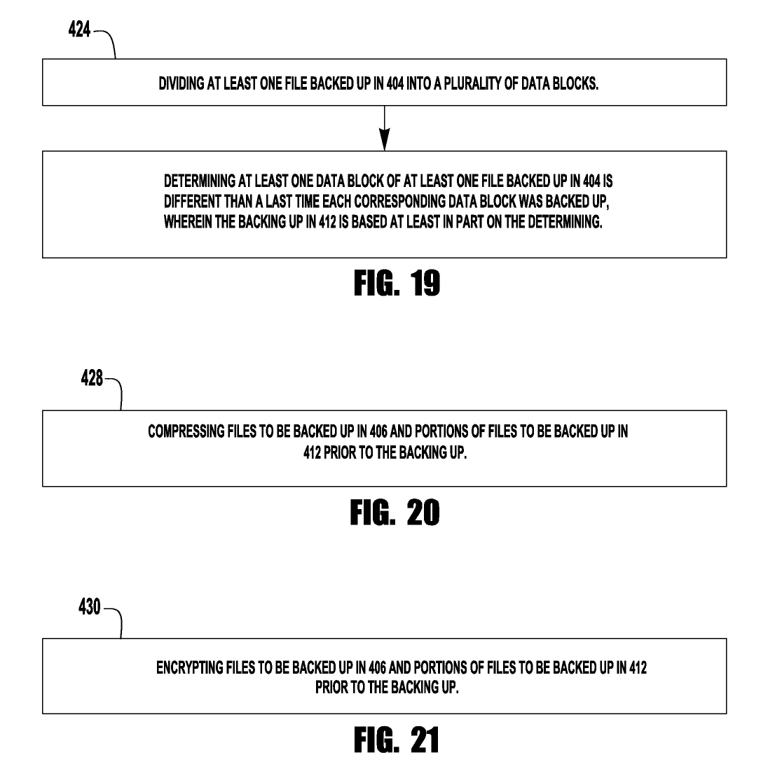

With reference to FIGS. 17 and 19, yet another exemplary embodiment of a process 400 for providing a data backup service may also include dividing at least one file backed up in b) into a plurality of data blocks (424). At 426, the process may determine at least one data block of at least one file backed up in 404 is different than a last time each corresponding data block was backed up. The backing up in 412 may be based at least in part on the determining in 426.

With reference to FIGS. 17 and 20, still another exemplary embodiment of a process 400 for providing a data backup service may also include compressing files to be backed up in 404 and portions of files to be backed up in 412 prior to the backing up (428).

With reference to FIGS. 17 and 21, still yet another exemplary embodiment of a process 400 for providing a data backup service may also include encrypting files to be backed up in 404 and portions of files to be backed up in 412 prior to the backing up (430).

While the invention is described herein in conjunction with one or more exemplary embodiments, it is evident that many alternatives, modifications, and variations will be apparent to those skilled in the art. Accordingly, exemplary embodiments in the preceding description are intended to be illustrative, rather than limiting, of the spirit and scope of the invention. More specifically, it is intended that the invention embrace all alternatives, modifications, and variations of the exemplary embodiments described herein that fall within the spirit and scope of the appended claims or the equivalents thereof. Any element in a claim that does not explicitly state “means for” performing a specified function, or “step for” performing a specific function, is not to be interpreted as a “means” or “step” clause as specified in 35 U.S.C. § 112, ¶6. In particular, the use of “step of” in the claims herein is not intended to invoke the provisions of 35 U.S.C. § 112, ¶6. Further, the description of the embodiments above does not limit the scope of the claims in any way and the language of the claims has all of its full ordinary meaning.

1. A method of providing a data backup service, including:
a) locating a data backup device at a first device address;
b) backing up one or more stored files from at least one storage device to the data backup device at the first device address;
c) maintaining address information for the data backup device at a locator service device in operative communication with the data backup device;
d) retrieving address information for the data backup device from the locator service device, wherein the address information indicates the data backup device is identified by a second device address different from the first device address; and
e) backing up at least one portion of the one or more stored files from the at least one storage device to the data backup device at the second device address.

2. The method of claim 1, further including:
f) broadcasting a request to back up the one or more stored files from the at least one storage device to the data backup device over a local area network in operative communication with the at least one storage device;
g) performing a security check to confirm data backups from the at least one storage device to the data backup device are authorized;
h) upon successful completion of the security check, performing an authentication check to confirm an identity of a computer device from which the request in f) was broadcast; and
i) upon successful completion of the authentication check, performing the backing up in b).

3. The method of claim 1, further including:
f) receiving address information for the data backup device at the locator service device indicating address information for the data backup device is different from corresponding information associated with the first device address;
g) performing a security check to confirm data backups to the data backup device are authorized;
h) upon successful completion of the security check, performing an authentication check to confirm information received in f) was sent by the data backup device; and
i) upon successful completion of the authentication check, performing the maintaining in c).

4. The method of claim 1, further including:
f) determining at least one file backed up in b) is different than a last time each corresponding file was backed up;
g) failing in an attempt to back up the at least one file determined in f) to the data backup device at the first device address;
h) broadcasting a request to back up at least one portion of at least one file backed up in
b) to the data backup device over a local area network in operative communication with the at least one storage device;
i) determining the data backup device is not located within the local area network based at least in part on not receiving a response from the data backup device;
j) transmitting a request for address information for the data backup device to the locator service device over a communication network in operative communication the local area network and locator service device;
k) performing a security check to confirm data backups from the at least one storage device to the data backup device are authorized;
l) upon successful completion of the security check, performing an authentication check to confirm an identity of a computer device from which the request in j) was transmitted; and
m) upon successful completion of the authentication check, transmitting a response to the request in j) indicating the data backup device is in operative communication with the communication network at the second device address and performing the backing tip in e).

5. The method of claim 1, further including:
f) backing up a first stored file from the at least one storage device to the data backup device at the first device address;
g) determining a second stored file from the at least one storage device is a duplicate of the file backed up in f); and
h) backing up the second stored file to the data backup device at the first device address using at least one pointer to reference the file backed up in f).

6. The method of claim 1, further including:
f) dividing a first stored file from the at least one storage device into a plurality of data blocks;
g) backing up a first stored file to the data backup device at the first device address by backing up each of the plurality of data blocks;
h) dividing a second stored file from the at least one storage device into a plurality of data blocks, wherein at least one data block of the second stored file is a duplicate of a corresponding data block in the first stored file; and
i) backing up the second stored file to the data backup device at the first device address using at least one pointer to reference each duplicate data block of the second stored file to the corresponding data block in the file stored file backed up in g).

7. The method of claim 1, further including:
f) determining at least one file backed up in b) is different than a last time each corresponding file was backed up,
wherein the backing up in e) is based at least in part on the determining.
g) compressing files to be backed up in b) and portions of files to be backed up in e) prior to the backing up; and
h) encrypting files to be backed up in b) and portions of files to be backed up in e) prior to the backing up.

8. The method of claim 1, further including:
f) dividing at least one file backed up in b) into a plurality of data blocks;
g) determining at least one data block of at least one file backed up in b) is different than a last time each corresponding data block was backed up, wherein the backing up in e) is based at least in part on the determining;
h) compressing files to be backed up in b) and portions of files to be backed up in e) prior to the backing up; and
i) encrypting files to be backed up in b) and portions of files to be backed up in e) prior to the backing up.

9. The method of claim 1, further including:
f) restoring the files backed up in b) and e) from the data backup device to the at least one storage device from which the corresponding files were backed up, wherein the data backup device is located at the first device address for the restoring.

10. The method of claim 1, further including:
f) restoring one file backed up in b) and e) from the data backup device to the at least one storage device from which the corresponding file was backed up, wherein the data backup device is located at the second device address for the restoring.

11. A method of providing a data backup service, including:
a) interfacing a portable data backup appliance with a first network;
b) backing up select stored data to the portable data backup appliance via the first network;
c) interfacing the portable data backup appliance with a second network; and
d) backing up at least one portion of the select stored data to the portable data backup appliance via the second network.

12. The method of claim 11, further including:
e) transmitting a request to back up at least one portion of the select stored data to the portable data backup appliance over the first network;
f) determining the portable data backup appliance is accessible via the first network based at least in part on a response from the portable data backup appliance or determining the portable data backup appliance is not accessible via the first network based at least in part on no response from the portable data backup appliance;
g) transmitting address information from the portable data backup appliance to a locator service;
h) if the portable data backup appliance is not accessible via the first network, transmitting a request for address information for the portable data backup appliance to the locator service; and
i) if the data backup appliance is not accessible via the first network, determining the portable data backup appliance is accessible via the second network based at least in part on address information in a response from the locator service.

13. The method of claim 11, further including:
e) dividing the select stored data into a plurality of data blocks; and
f) determining at least one data block of the select stored data backed up in b) is different than a last time each corresponding data block was backed up;
wherein the backing up in d) is based at least in part on the determining in f).

14. A data backup system, including:
a data backup appliance adapted to be located at a first device address in operative communication with at least one storage device;
a locator service adapted to maintain address information for the data backup appliance; and
a data backup client in operative communication with the data backup appliance and locator service and adapted to: i) specify one or more files stored on the at least one storage device for backup, ii) locate the data backup appliance at the first device address, iii) back up the one or more specified files to the data backup appliance at the first device address, iv) retrieve address information for the data backup appliance from the locator service indicating the data backup appliance is identified by a second device address different from the first device address, and v) back up at least one data portion of the one or more specified files to the data backup appliance at the second device address.

15. The data backup system of claim 14, the data backup appliance including:
a communication logic adapted to transmit address information to the locator service and to receive a request to back up the one or more files stored on the at least one storage device;
a security check logic adapted to perform a security check to confirm data backups from the at least one storage device to the data backup appliance are authorized; and
an authentication logic adapted to perform an authentication check to confirm an identity of a computer device from which any request to back up the one or more files received by the communication logic was sent.

16. The data backup system of claim 14, the locator service including:
a communication logic adapted to receive address information for the data backup appliance and to receive a request for address information associated with the data backup appliance;
a security check logic adapted to perform at least one of a first security check to confirm data backups to the data backup appliance associated with address information received by the communication logic are authorized and a second security check to confirm data backups from a storage device to the data backup appliance associated with the request for address information received by the communication logic are authorized; and
an authentication logic adapted to perform at least one of a first authentication check to confirm address information received by the communication logic was sent by the data backup appliance and a second authentication check to confirm an identity of a computer device from which any request for address information associated with the data backup appliance received by the communication logic was transmitted.

17. The data backup system of claim 14, the data backup client including:
a communication logic adapted to: i) broadcast a request to back up at least one portion of the one or more specified files to the data backup appliance over a local area network in operative communication with the at least one storage device; ii) receive a response to the request broadcast over the local area network, iii) determine the data backup appliance is not located within the local area network based at least in part on not receiving a response to the request broadcast over the local area network, iv) transmit a request for address information for the data backup appliance to the locator service over a communication network in operative communication the local area network and locator service, and v) receive a response to the request transmitted over the communication network;
a compression logic adapted to compress files to be backed up to the data backup appliance and portions of files to be backed up to the data backup appliance prior to the backing up; and
an encryption logic adapted to encrypt files to be backed up to the data backup appliance and portions of files to be backed up to the data backup appliance prior to the backing up.

18. The data backup system of claim 14, the data backup client including:
a delta backup logic adapted to: i) divide a first stored file from the at least one storage device into a plurality of data blocks and ii) divide a second stored file from the at least one storage device into a plurality of data blocks; and
a de-duplication logic adapted to: i) back up the first stored file to the data backup appliance at the first device address by backing up each of the plurality of data blocks, ii) determine at least one data block of the second stored file is a duplicate of a corresponding data block in the first stored file, iii) back up the second stored file to the data backup appliance at the first device address using at least one pointer to reference each duplicate data block of the second stored file to the corresponding data block in the first stored file, iv) determine the second stored file from the at least one storage device is a duplicate of the first stored file, and v) back up the second stored file to the data backup appliance at the first device address using at least one pointer to reference the first stored file.

19. The data backup system of claim 14, the data backup client including:
a delta backup logic adapted to: i) divide at least one file to be backed up to the data backup appliance into a plurality of data blocks, ii) determine at least one data block of at least one file backed up to the data backup appliance is different than a last time each corresponding data block was backed up, iii) determine at least one file backed up to the data backup appliance is different than a last time each corresponding file was backed up, and iv) recognize failure of the backing up of files or portions of files to the data backup appliance.

20. A method of providing a data backup service, including:
a) backing up one or more stored files from at least one storage device to a data backup device;
b) maintaining address information for the data backup device at a locator service device;
c) retrieving address information for the data backup device from the locator service device; and
d) backing up at least one portion of the one or more stored files from the at least one storage device to the data backup device using the retrieved address information.

21. A data backup appliance, including:
a communication logic adapted to transmit address information to a locator service associated with an internet and to receive a request to back up one or more files stored on at least one storage device associated with the internet;
a security check logic adapted to perform a security check to confirm data backups from the at least one storage device to the data backup appliance are authorized; and
an authentication logic adapted to perform an authentication check to confirm an identity of a computer device associated with the internet from which any request to back up the one or more files received by the communication logic was sent;
wherein the data backup appliance is adapted to be located within the internet in operative communication with the locator service, the at least one storage device, and the computer device.
